(19) United States
(12) Patent Application Publication
(10) Pub. No.: US 2026/0171592 A1
(43) Pub. Date: Jun. 18, 2026

(54) SECONDARY BATTERY AND METHOD OF MANUFACTURING THE SAME

(71) Applicant: Samsung SDI Co., Ltd., Yongin-si (KR)

(72) Inventor: Kiyoun Jeon, Yongin-si (KR)

(73) Assignee: Samsung SDI Co., Ltd., Yongin-si (KR)

(21) Appl. No.: 19/365,402

(22) Filed: Oct. 22, 2025

(30) Foreign Application Priority Data
Dec. 13, 2024 (KR) 10-2024-0186537

(51) Int. Cl. H01M 50/342; B60L 50/64; H01M 50/103; H01M 50/15; H01M 50/169

(52) U.S. Cl. CPC H01M 50/3425; H01M 50/103; H01M 50/15; H01M 50/169; B60L 50/64; H01M 2220/20

(57) ABSTRACT

The present disclosure provides a secondary battery, which has a battery can and a vent portion formed at a welding portion of a sealing member that seals the battery can, and thus there is no need to form a hole or apply a separate part to make the vent portion, thereby easily manufacturing the secondary battery, and a method of manufacturing the same, which enables the manufacturing of a secondary battery with a safer structure because the vent trigger pressure is accurately designed by controlling the welding strength of the welding portion. The secondary battery includes a battery can that provides a space for accommodating an electrode assembly and opens toward the outside of the secondary battery, the electrode assembly accommodated in the battery can, and a cap assembly including a cap plate coupled to an upper end portion of the battery can by welding to seal the battery can, wherein a welding portion that couples the battery can to the cap plate includes a first welding portion and a second welding portion that provide different bonding forces.

### CROSS-REFERENCE TO RELATED APPLICATIONS

This present application claims priority to and the benefit under 35 U.S.C. § 119(a)-(d) of Korean Patent Application No. 10-2024-0186537, filed on Dec. 13, 2024, in the Korean Intellectual Property Office, the entire disclosure of which is incorporated herein by reference.

### FIELD

The present disclosure relates to a secondary battery and a method of manufacturing the same, and more specifically, to a secondary battery having a structure in which a welding portion of a battery can opens to serve as a vent portion, and a method of manufacturing the same.

### BACKGROUND

Secondary batteries are batteries that can be charged or discharged, unlike primary batteries that cannot be recharged. Generally, secondary batteries include an electrode assembly composed of a positive electrode plate, a negative electrode plate, and a separator, and an outer case (battery can or case) that accommodates the electrode assembly. The types of electrode assemblies may be classified into a wound type and a stacked type depending on the stacked form of the electrode plates and separator. The wound type electrode assembly is called a jelly roll, and the stacked type electrode assembly is called a stack. Further, the types of secondary batteries may be classified into a pouch type, a cylindrical type, a prismatic type, and the like depending on the material and shape of an outer case.

A battery cell of a secondary battery is provided with a vent portion. The vent portion opens when the internal pressure of the battery cell increases and serves to discharge gas. The vent portion is formed by forming a hole in one side of a battery can and blocking the hole using a blocking plate. The blocking plate is ruptured when the internal pressure increases, and gas is vented. However, conventional secondary batteries have a disadvantage in that a vent portion is ruptured only when there is nearly predetermined pressure.

The above information disclosed in this Background section is for enhancement of understanding of the background of the present disclosure, and therefore, it may contain information that does not constitute related (or prior) art.

### SUMMARY

The present disclosure is directed to providing a secondary battery that is easily manufactured because there is no need to form a hole or apply a separate part to make a vent portion.

The present disclosure is also directed to providing a method of manufacturing a secondary battery which allows a vent trigger pressure to be accurately designed by adjusting a welding strength of a welding portion.

According to aspects of the present disclosure, there is provided a secondary battery which includes a battery can that provides a space for accommodating an electrode assembly and opens toward an outside of the secondary battery, the electrode assembly accommodated in the battery can, and a cap assembly including a cap plate coupled to an upper end portion of the battery can by welding to seal the battery can, wherein a welding portion that couples the battery can to the cap plate includes a first welding portion and a second welding portion that provide different bonding forces.

According to aspects of the present disclosure, there is provided a secondary battery which includes a battery can that provides a space for accommodating an electrode assembly, has one open side, and has terminals, the electrode assembly accommodated in the battery can and connected to the terminals, and a cover having an edge portion coupled to the battery can by welding covering, and sealing an internal space of, the battery can, wherein welding portions that connect the battery can to the cover includes a first welding portion and a second welding portion that provide different bonding forces.

According to aspects of the present disclosure, there is provided a method of manufacturing a secondary battery, including mounting a sealing member in an opening of a battery can that opens toward an outside of the secondary battery through the opening, and welding the battery can and the sealing member, which are in a close contact state, to one another through a first welding portion (\ and a second welding portion that provide different bonding forces.

Aspects and features of the present disclosure are not limited to those described herein, and other aspects and features not specifically mentioned herein will be clearly understood by those skilled in the art from the description of the present disclosure

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings, in which:

FIG. 1 is a perspective view of a secondary battery according to embodiments of the present disclosure;

FIG. 2 is a cross-sectional view along line A-A of FIG. 1.

FIGS. 3 and 4 are plan views illustrating several implementation examples of the secondary battery according to embodiments of the present disclosure;

FIGS. 5 and 6 are cross-sectional views illustrating exteriors of a first welding portion (W1) and a second welding portion (W2) of FIG. 3;

FIGS. 7 and 8 are cross-sectional views illustrating other exteriors of the first welding portion (W1) and the second welding portion (W2) of FIG. 3;

FIG. 9 is a view illustrating a modified example of a battery can illustrated in FIG. 1;

FIG. 10 is a cutaway perspective view for describing a function of a welding avoidance groove illustrated in the battery can of FIG. 9;

FIGS. 11 to 13 are plan views illustrating a cap plate that is welded to the battery can of FIG. 9;

FIG. 14 is a perspective view of another type of secondary battery according to embodiments of the present disclosure;

FIG. 15 is an exploded perspective view of the secondary battery illustrated in FIG. 14;

FIGS. 16 to 18 are views for describing several implementation examples of the secondary battery illustrated in FIG. 14;

FIGS. 19 to 22 are views for describing features of a welding portion of a cover of the battery can in the secondary battery of FIG. 14;

FIGS. 23 to 26 are views illustrating various modified examples of the battery can in the secondary battery according to embodiments of the present disclosure;

FIG. 27 is a perspective view of a secondary battery pack in which the secondary battery according to embodiments of the present disclosure is embedded;

FIG. 28 is a view illustrating an automobile on which the secondary battery pack of FIG. 27 is mounted; and

FIG. 29 is a view for describing a method of manufacturing the secondary battery according to embodiments of the present disclosure.

### DETAILED DESCRIPTION

Hereinafter, embodiments of the present disclosure will be described, in detail, with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her disclosure in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C,” “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

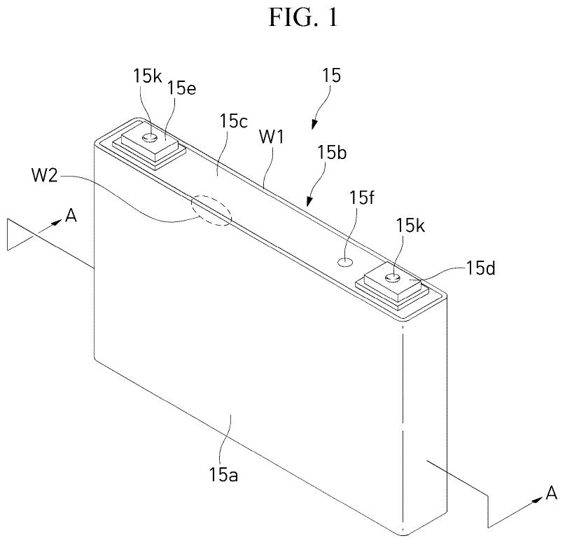

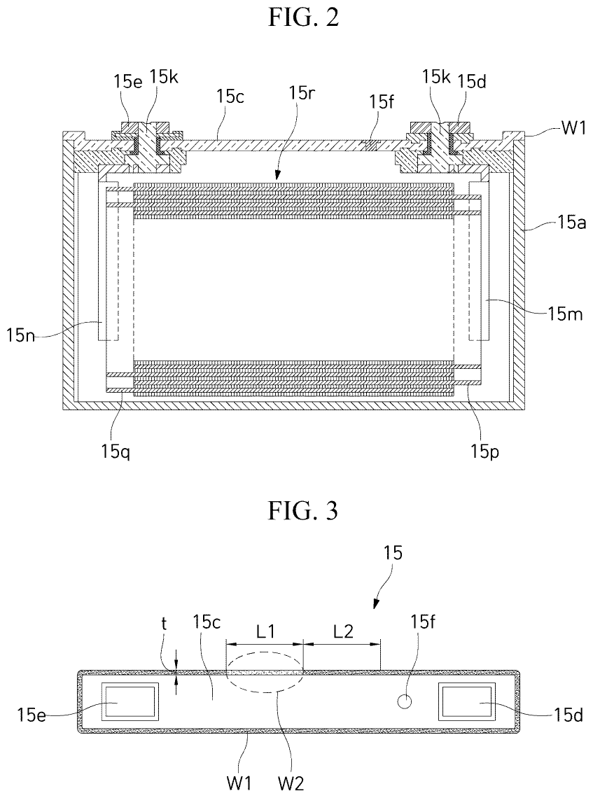

FIG. 1 is a perspective view of a secondary battery 15 according to embodiments of the present disclosure, and FIG. 2 is a cross-sectional view along line A-A of FIG. 1.

A battery can 15a forms an overall exterior of a prismatic secondary battery and may be formed of a conductive metal such as aluminum, an aluminum alloy, or nickel-plated steel. Further, the battery can 15a may provide a space in which an electrode assembly 15r is accommodated.

A cap assembly 15b may include a cap plate 15c that covers an opening of the battery can 15a. In some embodiments, the battery can 15a and the cap plate 15c may be made of a conductive material. Here, a first terminal 15d and a second terminal 15e may be installed to be electrically connected to positive and negative electrodes tabs therein and exposed to the outside of the cap plate 15c.

An electrolyte inlet 15f may be formed in the cap plate 15c. In particular, a vent portion is omitted from the cap plate. Since a first welding portion W1 (w2) is formed in place of the vent portion, the vent portion may be omitted. A description thereof will be described herein.

FIG. 2 is a cross-sectional view along line A-A of FIG. 1.

The electrode assembly 13a may be formed by winding or stacking a first electrode plate, a separator, and a second electrode plate formed in a plate shape or film shape. When the electrode assembly 15r is a wound stack, a winding axis may be parallel to the longitudinal direction of the case. In some embodiments, the electrode assembly 15r is a stack type rather than a winding type. The shape of the electrode assembly 15r is not limited in the present disclosure.

In addition, the electrode assembly 15r may be a Z-stack electrode assembly in which a positive electrode plate and a negative electrode plate are inserted into both sides of a separator, which is then bent into a Z-stack. In addition, one or more electrode assemblies 15r may be stacked such that long sides of the electrode assemblies are adjacent to each other and accommodated in the case, and the number of electrode assemblies in the case is not limited in the present disclosure. The first electrode plate of the electrode assembly 15r may act as a negative electrode, and the second electrode plate may act as a positive electrode. Of course, the reverse is also possible.

The first electrode plate may be formed by applying a first electrode active material, such as graphite, carbon, or the like, to a first electrode current collector formed of a metal foil, such as copper, a copper alloy, nickel, a nickel alloy, or the like. The first electrode plate may include a first electrode tab 43 (e.g., a first uncoated portion) that is a region to which the first electrode active material is not applied. The first electrode tab 15p may act as a current flow path between the first electrode plate and the first current collector 15m. In some embodiments, when the first electrode plate is manufactured, the first electrode tab 15p is formed by being cut in advance to protrude to one side of the electrode assembly, or the first electrode tab protrudes to one side of the electrode assembly more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab 15q (e.g., a second uncoated portion) that is a region to which the second electrode active material is not applied. The second electrode tab 15q may act as a current flow path between the second electrode plate and the second current collector 15n. In some embodiments, the second electrode tab 15q may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

An electrode material with which the herein-described electrode tab is coated may be in the form of a slurry, and a method of coating the electrode tab with the electrode material may be applied. Materials that can be used for the electrode material are as follows.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O ₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x≤2), a Si-based alloy, or a combination thereof.

The silicon-carbon composite may be a composite of silicon and amorphous carbon. According to embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particles and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

The separator prevents or substantially reduces instances of a short circuit between the first electrode and the second electrode while allowing movement of lithium ions therebetween. The separator may be made of, for example, a polyethylene film, a polypropylene film, a polyethylene-polypropylene film, or the like.

In some embodiments, an electrode assembly 15r is accommodated in the case 15a along with an electrolyte.

In the electrode assembly 15r, the first current collector 15m and the second current collector 15n may be welded and connected to the first electrode tab 15p extending from the first electrode plate and the second electrode tab 15q extending from the second electrode plate, respectively.

The first current collector 15m and the second current collector 15n are electrically connected to the positive electrode terminal 15d and the negative electrode terminal 15e described in FIG. 1, respectively, through connecting members 15k. In some embodiments, an outer circumferential surface of the connecting member 15k may be processed to have screws and fastened to the positive electrode terminal 15d and the negative electrode terminal 15e through screw joining. However, the present disclosure is not limited thereto, and the connecting member 15k may be connected to each of the positive electrode terminal 15d and the negative electrode terminal 15e by riveting or welding.

Meanwhile, the cap plate 15c is fixed to an upper end portion of the battery can 15a by welding. That is, the cap assembly 15b is placed on an upper end of the battery can 15a and welded along a circumference of the upper end of the battery can 15a. The cap plate 15c may be coupled to an upper end portion of the battery can 15a by welding to seal an internal space of the battery can. Since a welding portion extends along the circumference of the upper end portion of the battery can, the welding portion itself may have a substantially quadrangular shape.

In particular, the welding portion that connects the battery can 15a and the cap plate 15c may include a first welding portion W1 and a second welding portion W2. The first welding portion W1 and the second welding portion W2 are not disconnected from each other but are connected to each other and may provide different bonding forces. The herein-described “bonding force” refers to a bonding strength of the cap plate 15c to the battery can 15a. The bonding forces, in other words, the welding strengths, of the first welding portion W1 and the second welding portion W2 may be different from each other.

In embodiments, the welding strength of the first welding portion W1 may be greater than the welding strength of the second welding portion W2. This means that when an external force is applied, a welded surface of the second welding portion W2 may be relatively easily ruptured compared to a welded surface of the first welding portion W1. Eventually, when the internal pressure of the battery can 15a increases, the second welding portion W2 may open prior to the first welding portion W1 to vent gas. A gas vent path in embodiments may be formed along a gap between the battery can 15a and the cap plate 15c.

The first welding portion W1 and the second welding portion are portions formed by fusing an upper end surface of the battery can 15a and a bottom surface of an edge portion of the cap plate 15c plate that are in close contact with each other. An area of the welded surface welded by the second welding portion W2 is smaller than an area of the welded surface welded by the first welding portion W1.

As illustrated in FIG. 1, the second welding portion W2 is a portion of the welding portion that connects the battery can 15a and the cap plate 15c, and the remaining welding portion other than the second welding portion W2 is the first welding portion W1. The second welding portion W2 may be formed at the long side of the secondary battery forming a quadrangular shape.

FIG. 3 is a plan view illustrating one implementation example of the secondary battery 15 according to embodiments of the present disclosure.

As illustrated in the drawing, a first welding portion W1 and a second welding portion W2 may be formed along an edge portion of a cap plate 15c. For convenience, the first welding portion W1 is indicated by dark dots, and the second welding portion W2 is indicated by relatively light dots.

One second welding portion W2 may be formed on the secondary battery 15 illustrated in FIG. 3. The entirety of the remaining welding portion is the first welding portion W1. As described herein, since the welding strength of the first welding portion W1 is greater than the welding strength of the second welding portion W2, when an internal pressure of the secondary battery 15 increases, the second welding portion W2 may be ruptured and gas may be vented through a gap of the ruptured second welding portion W2. The location and size of the second welding portion W2 may be implemented in various manners through other embodiments. As illustrated in FIG. 3, the second welding portion W2 is installed at one location but may be formed at a plurality of locations.

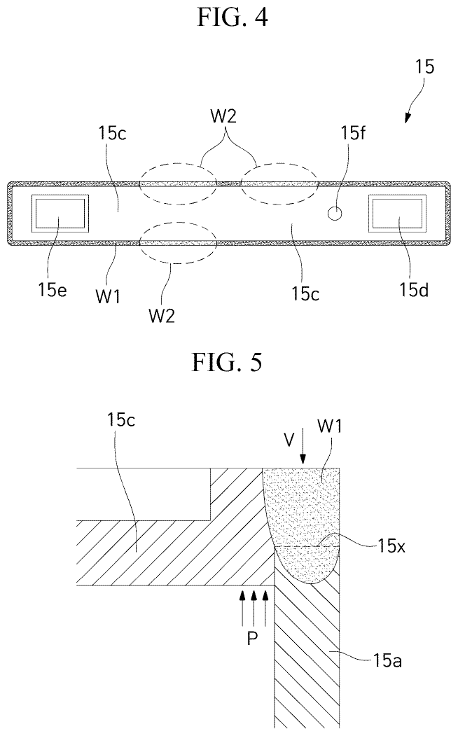

In the case of the secondary battery 15 illustrated in FIG. 4, second welding portions W2 are located at three locations. That is, in the drawing, two second welding portions W2 are located on an upper long side and one second welding portion W2 is located on a lower long side. When an internal pressure of the secondary battery increases, one of the three second welding portions W2 may be ruptured. In some cases, the plurality of second welding portions W2 may be ruptured simultaneously.

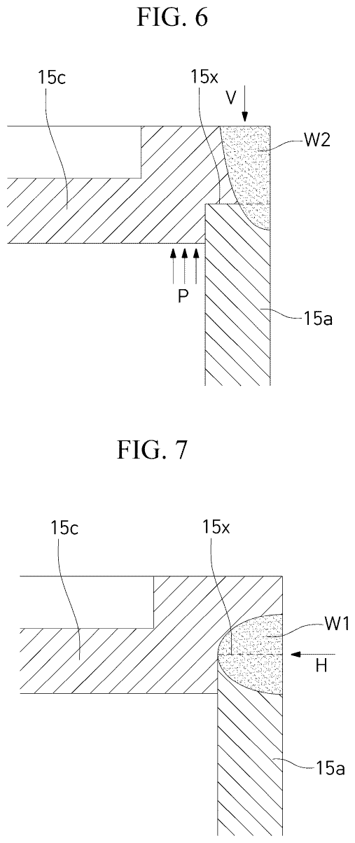

FIGS. 5 and 6 are cross-sectional views illustrating exteriors of the first welding portion W1 and the second welding portion W2 of FIG. 3. A welding direction from the cap plate 15c to the battery can 15a may be a vertical or horizontal direction.

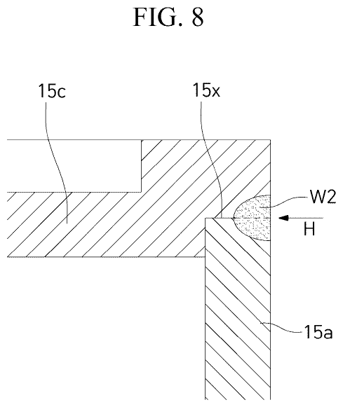

In this description, vertical welding may be welding performed by applying welding heat vertically from the top of the secondary battery, i.e. in a direction of arrow V. Further, horizontal welding may be welding performed by applying welding heat from a side portion of the secondary battery in a direction of arrow H in FIGS. 7 and 8.

As illustrated in FIGS. 5 and 6, the first welding portion W1 and the second welding portion W2 penetrate the cap plate in a thickness direction on from upper surface of the cap plate 15c, penetrate a close contact surface 15x between the cap plate and the battery can, and reach an inside of the battery can. The close contact surface 15x may be an upper end surface of the battery can 15a or a bottom surface of an edge portion of the cap plate 15c.

As illustrated the drawings, it can be seen that a welded area (of the close contact surface 15x) welded via the first welding portion W1 is relatively greater than the welded area of a welded portion welded via the second welding portion W2. That is, the welded area of the welded portion welded via the first welding portion W1 is greater than the welded area of the welded portion welded via the second welding portion W2 per unit area of the close contact surface 15x.

The unit area of the second welding portion W2 in the present disclosure is the product of a thickness of the upper end portion of the battery can and a length L1 of the second welding portion W2. Further, the unit area of the first welding portion W1 is the product of a thickness of the upper end portion of the battery can and a length L2 that is the same as the length L1 of the second welding portion W2.

Within regions having the same area, the welded area of the welded portion welded via the first welding portion W1 is relatively greater than the welded area of the welded portion welded via the second welding portion W2. Since the welded area is greater, the bonding force is relatively stronger. That is, the welding strength is relatively greater. Accordingly, as illustrated in FIGS. 5 and 6, when pressure in a direction of arrow P is applied to the cap plate 15c, the first welding portion W1 is not ruptured, whereas the second welding portion W2 is ruptured.

FIGS. 7 and 8 are cross-sectional views illustrating other exteriors of the first welding portion W1 and the second welding portion W2 of FIG. 3. FIGS. 7 and 8 are examples in which the close contact surface 15x is welded in a horizontal direction. As described, the horizontal welding may be welding performed by applying welding heat from the side portion of the secondary battery in the direction of arrow H in FIGS. 7 and 8.

As illustrated in the drawings, the first welding portion W1 and the second welding portion W2 enter the close contact surface 15x between the battery can and the cap plate from a side portion of an upper end of the battery can 15a. In a similar manner as illustrated in FIGS. 5 and 6, a welded area of a welded portion welded via the first welding portion W1 is greater than a welded area of a welded portion welded via the second welding portion W2 per unit area of the close contact surface 15x.

Referring to FIG. 7, an upper end surface of the battery can 15a is entirely welded to a bottom surface of an edge portion of the cap plate 15c. In contrast, in the case of FIG. 8, a portion of the upper end surface of the battery can 15a is not welded. That is, only a portion of the upper end surface is welded. In this way, since the welded areas of the welding portions of the first welding portion W1 and the second welding portion W2 are different, a bonding force provided by the first welding portion W1 is relatively greater than a bonding force provided by the second welding portion W2. When the internal pressure of the secondary battery increases, the second welding portion W2 may be ruptured.

The adjustment of the welded areas of the first welding portion W1 and the second welding portion W2 described herein may be implemented by adjusting welding energy for the welding portions. That is, the welding area may be expanded wider by increasing welding heat on a target surface, or the welding area may be reduced by reducing the welding heat. In other words, the first welding portion W1 and the second welding portion W2 may be formed by adjusting the input welding energy.

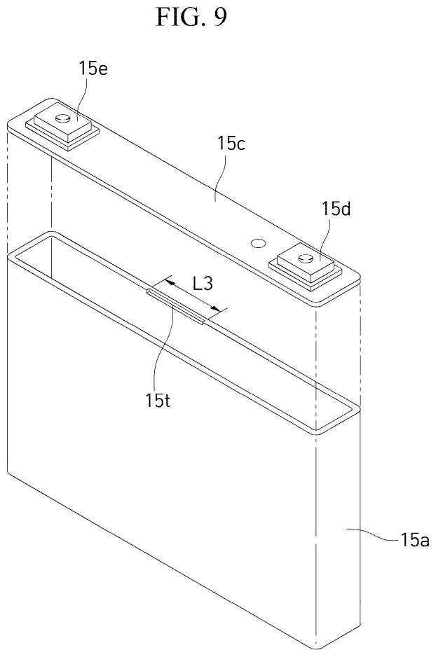

FIG. 9 is a view illustrating a modified example of the battery can 15a illustrated in FIG. 1.

As illustrated in the drawing, a welding avoidance groove 15t may be formed in an inner side of an upper end surface of the battery can 15a that corresponds to a bottom surface of an edge portion of the cap plate 15c. The welding avoidance groove 15t is a groove that opens toward the inside of the battery can 15a and may be spaced apart from the bottom surface of the cap plate. The welding portion does not reach the welding avoidance groove 15t. Since a bottom surface of the welding avoidance groove 15t is spaced apart from the bottom surface of the cap plate 15c, the welding portion does not reach the welding avoidance groove 15t. The welding avoidance groove 15t may be provided as one or more welding avoidance grooves 15t.

In the secondary battery of FIG. 9, the second welding portion W2 is a portion included in a region of length L3 including the welding avoidance groove 15t. The first welding portion W1 may include a region other than the second welding portion W2. In this way, since a welded area of a welded portion welded via the second welding portion W2 is smaller than a welded area of a welded portion welded via the first welding portion W1 per unit area, the bonding force provided by the second welding portion W2 is smaller than the bonding force provided by the first welding portion W1. Since the bonding force provided by the second welding portion W2 is smaller than the bonding force provided by the first welding portion W1, the second welding portion W2 may be ruptured when the internal pressure of the secondary battery increases.

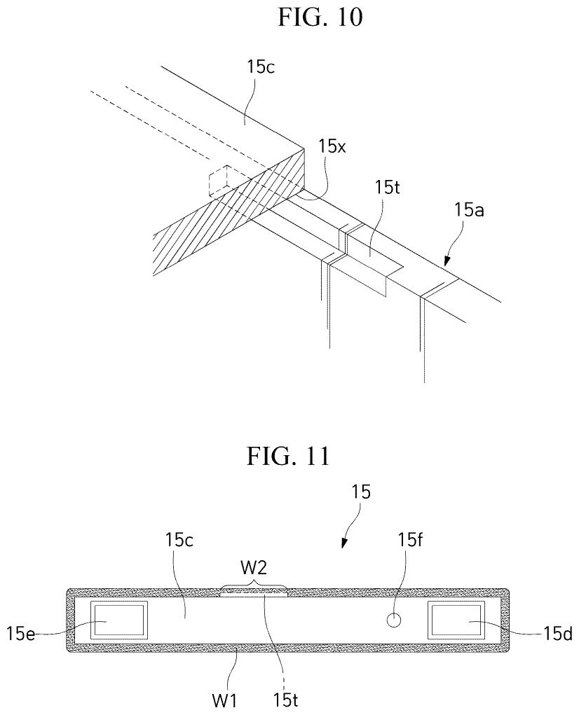

FIG. 10 is an enlarged cutaway perspective view illustrating the welding avoidance groove 15t in the battery can illustrated in FIG. 9.

As illustrated in the drawing, the bottom surface of the welding avoidance groove 15t is spaced apart from the bottom surface of the cap plate 15c. By applying the welding avoidance groove 15t in this way, the bonding force provided by the second welding portion W2 is smaller than the bonding force provided by the first welding portion W1 per unit area. When the internal pressure of the secondary battery increases, the second welding portion W2 may be ruptured in order to vent gas.

FIGS. 11 to 13 are plan views illustrating exteriors of a cap plate welded to the battery can of FIG. 9.

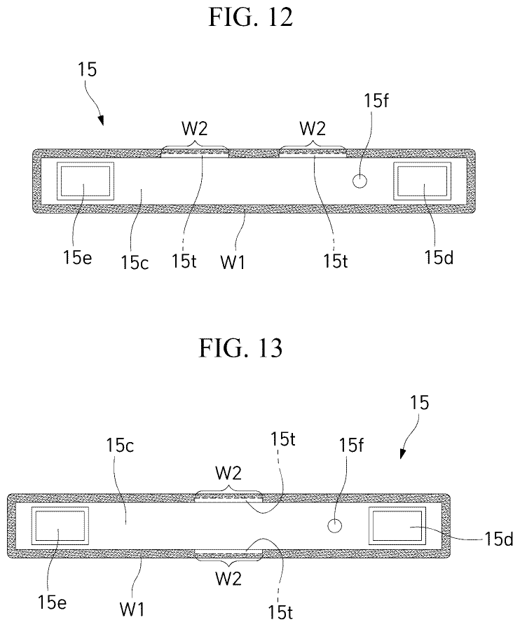

In a secondary battery 15 illustrated in FIG. 11, one welding avoidance groove 15t may be formed in an upper long side. A region including the welding avoidance groove 15t is a second welding portion W2, and the remaining portion is a first welding portion W1. Further, as illustrated in FIG. 12, a secondary battery 15 may have two welding avoidance grooves 15t in an upper long side thereof. Second welding portions W2 are located at two locations at one side. A secondary battery 15 of FIG. 13 has one welding avoidance groove 15t located in each of the long sides. The second welding portions W2 at two locations are symmetrical.

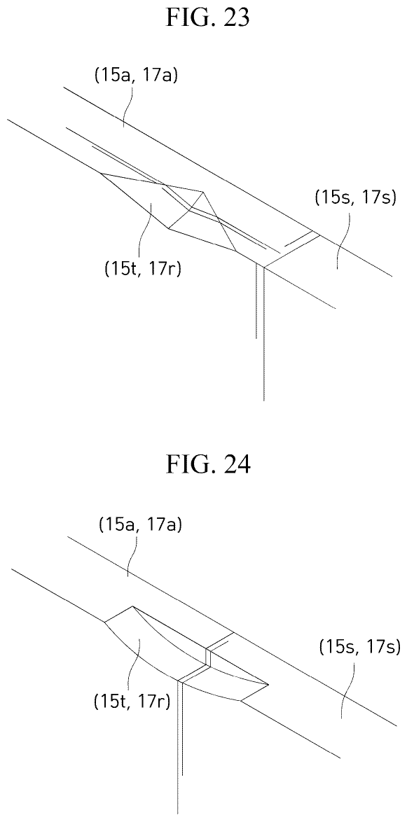

In this way, the number of applications and locations of welding avoidance grooves 15t may be changed in various manners through embodiments. In addition, the sizes and shapes of the welding avoidance grooves 15t may also be changed. For example, the welding avoidance grooves 15t may have the shapes illustrated in FIG. 23 to FIG. 26.

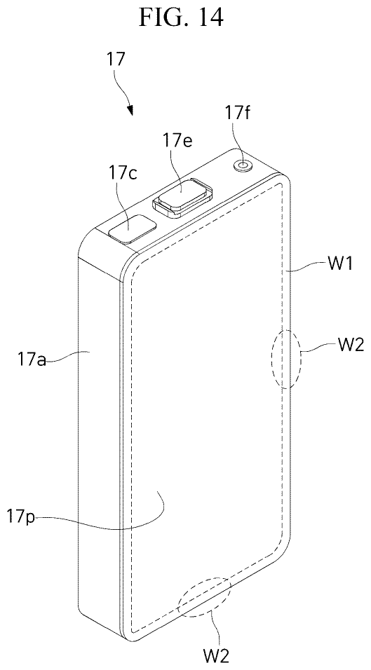

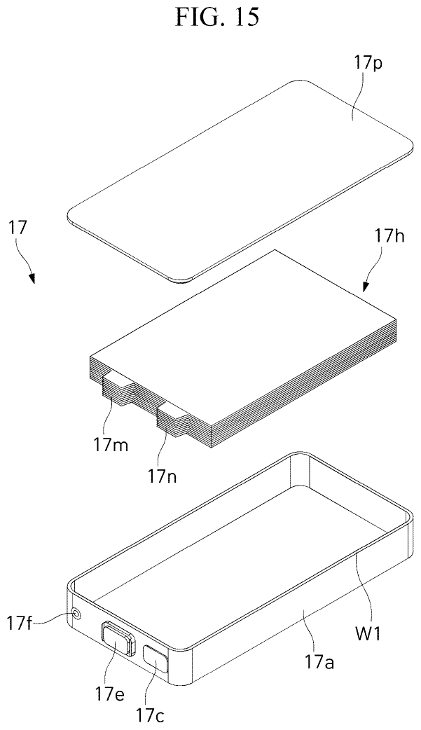

FIG. 14 is a perspective view of another type of secondary battery 17 according to embodiments of the present disclosure, and FIG. 15 is an exploded perspective view of the secondary battery of FIG. 14.

A prismatic secondary battery 17 illustrated in FIGS. 14 and 15 has a structure in which a wide surface of a battery can 17a (upper side in the drawing of FIG. 15) at a transverse side is an opening, an electrode assembly 17h is inserted into this opening, and a cover 17p covers the electrode assembly 17h. The cover 17p is fixed by welding in a state in which end portions of the opening of the battery can 17a are covered with the cover 17p. The cover 17p may seal an internal space of the battery can 17a. A first welding portion W1 and a second welding portion may be formed between the end portion of the opening of the battery can 17a and the cover 17p.

A first electrode tab 17m and a second electrode tab 17n of the electrode assembly 17h are connected to a first terminal 17c and a second terminal 17e, which are exposed to the outside of the battery can 17a, by welding inside the battery can 17a.

The electrode assembly 17h is assembled with the battery can 17a, then sealing with the cover 17p is performed, electrolyte is injected through an electrolyte inlet 17f, and then subsequent processes such as aging, pre-charging, etc., may be performed.

Second welding portions W2 may be located on side and lower portions of the secondary battery 17 having the above configuration. The locations and sizes of the second welding portions W2 may be changed based on other embodiments. A welding portion other than the second welding portions W2 is the first welding portion W1. A welding strength of the first welding portion W1 is relatively greater than a welding strength of the second welding portion W2. That is, a bonding force of a welded portion welded via the first welding portion W1 is relatively greater than the bonding force of a welded portion welded via the second welding portion W2, and thus when the internal pressure of the secondary battery increases, the second welding portions W2 may open to vent gas.

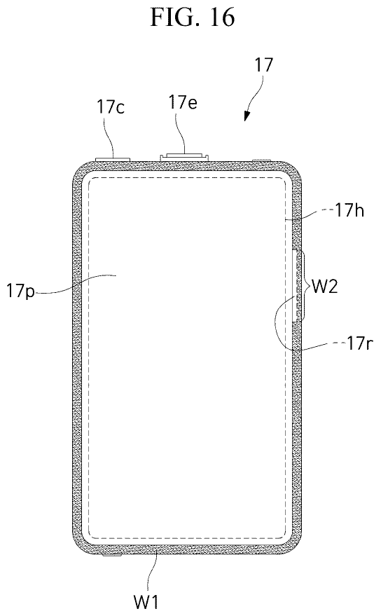

FIGS. 16 to 18 are views for describing several implementation examples of the secondary battery 17 illustrated in FIG. 14. For convenience, a portion where welding is performed is indicated with dots. The portion where the welding is performed is a portion where a cross-section of a side wall of a battery can and an edge portion of the cover 17p are in surface contact with each other.

As illustrated in FIG. 16, a welding avoidance groove 17r may be formed in a side portion of the secondary battery 17. A basic structure of the welding avoidance groove 17r may be the same as that illustrated in FIG. 10. The welding avoidance groove 17r is not welded and may form a second welding portion W2. The welding avoidance groove 17r is a space which opens toward an inside of the battery can and is spaced apart from the cover 17p and to which the welding portion does not reach. One or more welding avoidance grooves may be applied.

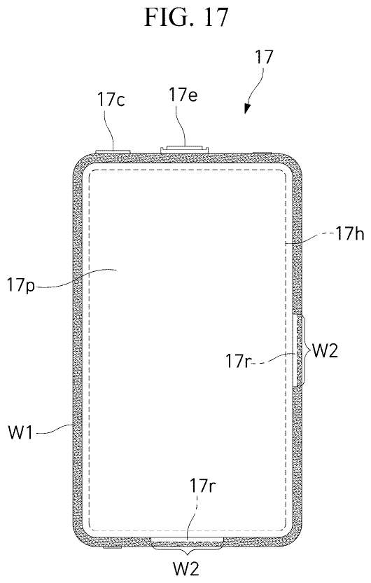

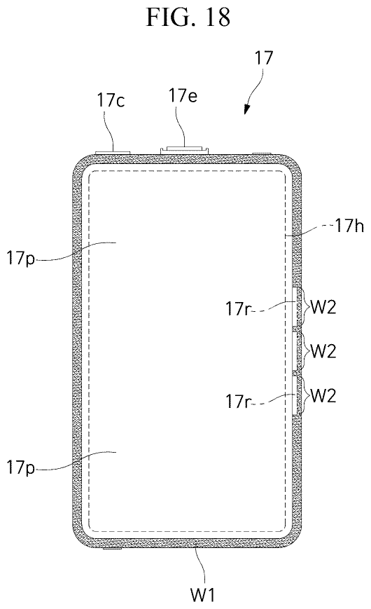

The secondary battery 17 illustrated in FIG. 17 is a type of secondary battery in which second welding portions W2 are formed on a side portion and a lower portion of the secondary battery. Further, a secondary battery 17 illustrated in FIG. 18 has second welding portions W2 in three locations on a side portion of the secondary battery.

An area of a welded surface welded via the herein-described second welding portion W2 is relatively smaller than an area of a welded surface welded via the first welding portion W1. In addition, the second welding portion W2, that is, the welding avoidance groove 17r, may be formed at one or more locations.

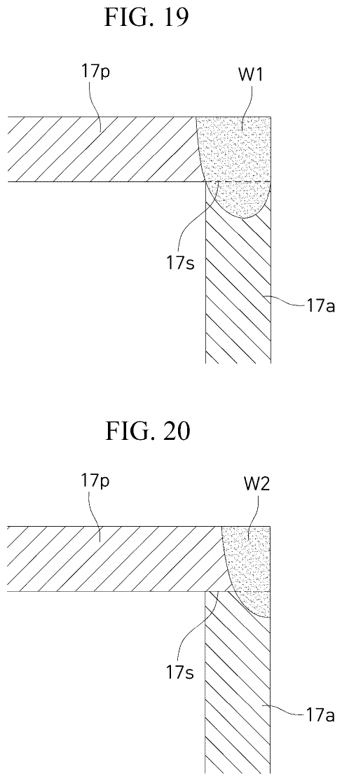

FIGS. 19 and 20 are views illustrating a first welding portion W1 and a second welding portion W2, respectively, formed through the herein-described vertical welding.

As illustrated in the drawings, the first welding portion W1 and the second welding portion W2 may penetrate a cover 17p in a thickness direction, penetrate a close contact surface 15x between the cover and a battery can 17a, and reach an inside of the battery can 17a. In this case, a welded area of a welded portion welded via the first welding portion W1 is greater than a welded area of a welded portion welded via the second welding portion W2 per unit area of the close contact surface 15x.

That is, the secondary battery illustrated in FIG. 19 has a close contact surface 17s entirely welded, whereas a secondary battery illustrated in FIG. 20 has the close contact surface 17s partially welded. Since the welded area of the welded portion welded via the first welding portion W1 is greater than the welded area of the welded portion welded via the second welding portion W2, the bonding force provided by the first welding portion W1 is relatively strong. Accordingly, the second welding portion W2 may be ruptured when the internal pressure of the secondary battery increases.

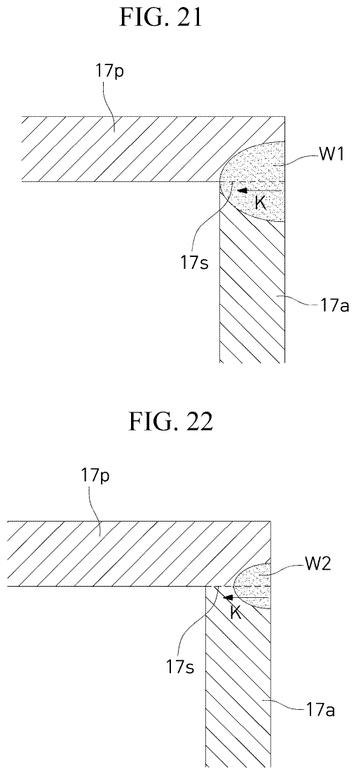

FIGS. 21 and 22 are views illustrating a first welding portion W1 and a second welding portion W2 formed through horizontal welding.

The first welding portion W1 and the second welding portion W2 are portions that enter in a direction of arrow k from a side portion of a battery can toward a close contact surface 17s of the battery can and a cover.

As described with reference to FIGS. 7 and 8, it can be seen that the welded area of the welded portion welded via the first welding portion W1 is greater than the welded area of the welded portion welded via the second welding portion W2 per unit area of the close contact surface 17s.

FIGS. 23 to 26 are views illustrating various welding avoidance grooves 15t and 17r applicable to battery cans 15a and 17a in the secondary battery according to embodiments of the present disclosure. Bottom surfaces of all shapes of welding avoidance grooves are spaced apart from a bottom surface of a cap plate or a bottom surface of a cover and are non-welded portions.

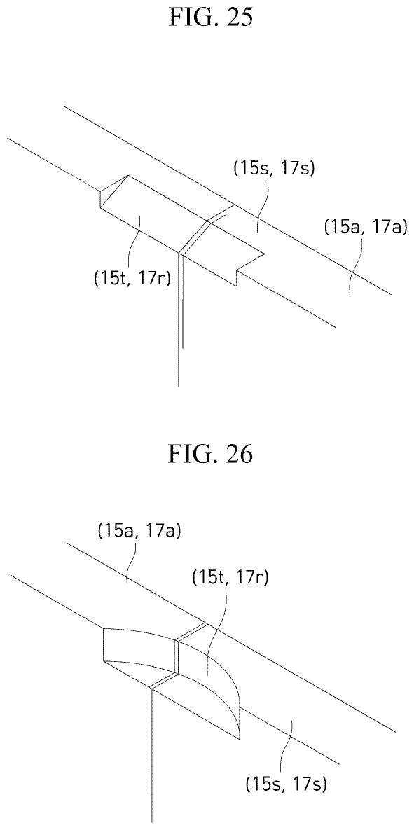

Welding avoidance grooves 15t and 17 r illustrated in FIG. 23 have a shape of a V-cut triangular groove. Further, a welding avoidance groove illustrated in FIG. 24 has a bottom surface of a rounded curve, and a welding avoidance groove illustrated in FIG. 25 has a shape that is inclined downward toward an internal space of a battery can. Further, a welding avoidance groove illustrated in FIG. 26 has a shape of a semicircular groove with a certain depth. The shape of the welding avoidance groove may be changed in various manners through other embodiments.

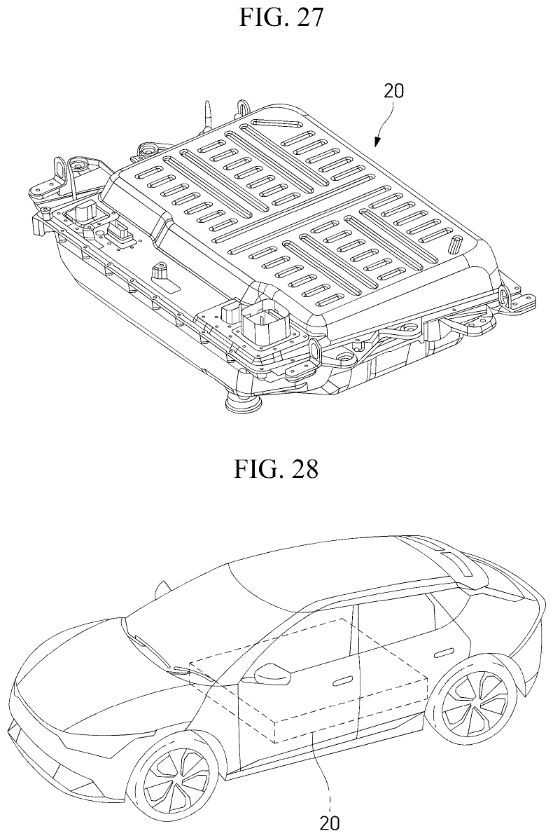

FIG. 27 is a perspective view of a secondary battery pack 20 to which the secondary battery 15 or 17 illustrated in FIG. 1 or 14 is applied.

The secondary battery pack 20 may be manufactured by embedding a plurality of secondary battery modules in a pack housing designed to be mounted on an actual product. The pack housing may include a fastener and an electrical outlet required for being mounted on a product. In FIG. 27, for convenience of illustration, bus bars for electrical connection of secondary batteries, and other related elements such as a cooling unit, an external terminal, and the like are omitted. The secondary battery pack may be mounted on an automobile. The automobile may be, for example, an electric vehicle, a hybrid vehicle, or a plug-in hybrid vehicle. The automobile includes a four-wheel drive or two-wheel drive vehicle.

FIG. 28 is a view illustrating an automobile on which the secondary battery pack 20 of FIG. 27 is mounted.

FIG. 28 illustrates an example in which the secondary battery pack 20 according to embodiments of the present disclosure is mounted on a lower portion of a body of the automobile. The automobile operates by receiving power from the secondary battery pack 20 according to embodiments of the present disclosure.

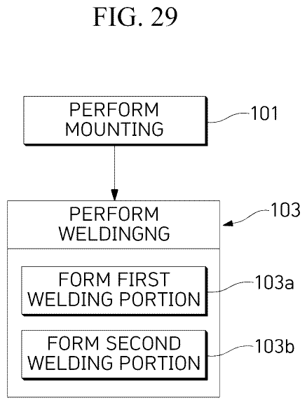

FIG. 29 is a view for describing a method of manufacturing the secondary battery according to embodiments of the present disclosure.

As illustrated in the drawing, the method of manufacturing the secondary battery according to embodiments may include a mounting operation 101 and a welding operation 103.

The mounting operation 101 is a process of mounting a sealing member to cover end portions of an opening of a battery can 15a or 17a. The opening is defined by end portions of wall surfaces of the battery can 15a or 17a. The sealing member may be a cap plate 15c included in a cap assembly or a plate-shaped cover 17p having a predetermined thickness.

Further, the welding operation 103 is a process of welding the battery can and the sealing member, which are in a close contact state, to each other through a first welding portion W1 and a second welding portion W2 that provide different bonding forces. As described herein, the welding strength of the second welding portion W2 is relatively smaller than the welding strength of the first welding portion W1. Further, the area of the welded surface welded via the second welding portion W2 is smaller than the area of the welded portion welded via the first welding portion W1.

The welding operation 103 may include a process 103a of forming the first welding portion W1 and a process 103b of forming the second welding portion W2.

The process 103a of forming the first welding portion W1 is a process of performing welding by applying welding heat to the battery can 15a or 17a and the cap plate 15c or the cover 17p (hereinafter, referred to as a “sealing member”). The welding method may be the vertical welding or horizontal welding described herein.

In the case in which the welding avoidance groove 15t or 17r is formed in the battery can 15a or 17a, the same welding heat is applied along a close contact surface between the battery can and the sealing member without making a distinction related to the welding avoidance groove. Since the welding avoidance groove portion is not welded, the first welding portion W1 and the second welding portion W2 may be automatically distinguished.

In the case in which there is no welding avoidance groove, welding may be performed by applying welding heat along the close contact surface between the battery can and the sealing member, and when the welding heat reaches a point where the second welding portion W2 is to be formed, the welding heat is lowered. Further, welding may be performed by increasing the welding heat after the welding heat penetrates the section of the second welding portion W2. In this way, the welding portions may be welded nonstop, or the first welding portion W1 and the second welding portion W2 may be formed sequentially. For example, the first welding portion W1 may be formed first, the welding heat may be lowered, and then the second welding portion W2 may be additionally formed.

Through the welding operation 103, the process of manufacturing the secondary battery 15 or 17 having the first welding portion W1 and the second welding portion W2 comes to an end.

The secondary battery of the present disclosure, which is formed as described herein, has a battery can and a vent portion formed at a welding portion of a sealing member that seals the battery can, and thus there is no need to form a hole or apply a separate part to make the vent portion, thereby easily manufacturing the secondary battery.

Further, the method of manufacturing the secondary battery enables the manufacturing of a secondary battery with a safer structure because a vent trigger pressure can be accurately designed by adjusting a welding strength of a welding portion.

Although the present disclosure has been described herein with respect to embodiments thereof, the present disclosure is not limited thereto. Various modifications and variations can be made thereto by those skilled in the art within the spirit of the present disclosure as defined by the appended claims and their equivalents.

What is claimed is:

1. A secondary battery comprising:
a battery can that provides a space for accommodating an electrode assembly and opens toward an outside of the secondary battery;
the electrode assembly accommodated in the battery can; and
a cap assembly including a cap plate coupled to an upper end portion of the battery can by welding to seal the battery can,
wherein a welding portion that couples the battery can to the cap plate comprises a first welding portion and a second welding portion that provide different bonding forces.

2. The secondary battery as claimed in claim 1, wherein the bonding force provided by the second welding portion is relatively smaller than the bonding force provided by the first welding portion so that the second welding portion opens prior to the first welding portion to vent gas when an internal pressure of the battery can increases.

3. The secondary battery as claimed in claim 2, wherein the first and second welding portions are portions formed by fusing an upper end surface of the battery can and a bottom surface of an edge portion of the cap plate that are in close contact with one another, and
an area of a welded surface of the second welding portion is smaller than an area of a welded surface of the first welding portion.

4. The secondary battery as claimed in claim 3, wherein the second welding portion is formed at one or more locations.

5. The secondary battery as claimed in claim 3, wherein the first welding portion and the second welding portion penetrate the cap plate in a thickness direction from an upper surface of the cap plate, penetrate a close contact surface between the cap plate and the battery can, and reach an inside of the battery can, and
a welded area of a welded portion welded by the first welding portion is greater than a welded area of a welded portion welded by the second welding portion per unit area of the close contact surface.

6. The secondary battery as claimed in claim 3, wherein the first welding portion and the second welding portion enter a close contact surface between the battery can and the cap plate from a side portion of an upper end of the battery can, and
a welded area of a welded portion welded by the first welding portion is greater than a welded area of a welded portion welded by the second welding portion per unit area of the close contact surface.

7. The secondary battery as claimed in claim 3, wherein a welding avoidance groove that opens toward an inside of the battery can and is spaced apart from a bottom surface of the cap plate and to which the welding portion does not reach is formed in an upper end surface of the battery can corresponding to the bottom surface of the cap plate.

8. The secondary battery as claimed in claim 7, wherein the welding avoidance groove is provided as one or more welding avoidance grooves.

9. A secondary battery comprising:
a battery can that provides a space for accommodating an electrode assembly, has one open side, and has terminals;
the electrode assembly accommodated in the battery can and connected to the terminals; and
a cover having an edge portion coupled to the battery can by welding covering and sealing an internal space of the battery can,
wherein welding portions that connect the battery can to the cover comprise a first welding portion and a second welding portion that provide different bonding forces.

10. The secondary battery as claimed in claim 9, wherein the bonding force provided by the second welding portion is relatively smaller than the bonding force provided by the first welding portion so that the second welding portion opens prior to the first welding portion to vent gas when an internal pressure of the battery can increases.

11. The secondary battery as claimed in claim 10, wherein an area of a welded surface welded by the second welding portion is smaller than an area of a welded surface welded by the first welding portion.

12. The secondary battery as claimed in claim 11, wherein the second welding portion is formed at one or more locations.

13. The secondary battery as claimed in claim 11, wherein the first welding portion and the second welding portion penetrate the cover in a thickness direction, penetrate a close contact surface between the cover and the battery can, and reach an inside of the battery can, and
a welded area of a welded portion welded by the first welding portion is greater than a welded area of a welded portion welded by the second welding portion per unit area of the close contact surface.

14. The secondary battery as claimed in claim 11, wherein the first welding portion and the second welding portion enter a close contact surface between the battery can and the cover from a side portion of the battery can, and
a welded area of a welded portion welded by the first welding portion is greater than a welded area of a welded portion welded by the second welding portion per unit area of the close contact surface.

15. The secondary battery as claimed in claim 10, wherein a welding avoidance groove that opens toward an inside of the battery can and is spaced apart from the cover and to which the welding portion does not reach is formed in an end portion of the battery can that is in close contact with the cover.

16. The secondary battery as claimed in claim 15, wherein the welding avoidance groove is provided as one or more welding avoidance grooves.

17. A method of manufacturing a secondary battery, comprising:
mounting a sealing member in an opening of a battery can that opens toward an outside of the secondary battery through the opening; and
welding the battery can and the sealing member, which are in a close contact state, to one another through a first welding portion and a second welding portion that provide different bonding forces.

18. The method as claimed in claim 17, wherein a welding strength of the second welding portion is smaller than a welding strength of the first welding portion.

19. The method as claimed in claim 18, wherein an area of a welded surface welded by the second welding portion is smaller than an area of a welded surface welded by the first welding portion.

20. The method as claimed in claim 17, wherein the sealing member comprises either a cap assembly or a plate-shaped cover.
